(19) United States
(12) Patent Application Publication
(10) Pub. No.: US 2012/0126040 A1
(43) Pub. Date: May 24, 2012

(54) POWERLESS DOUBLE-DISTRIBUTION PANS FERTILIZER DISTRIBUTOR

(76) Inventor: Wan Soo Kim, Jeollabuk-do (KR)

(21) Appl. No.: 13/387,884

(22) PCT Filed: Sep. 11, 2009
(86) PCT No.: PCT/KR09/05188

§ 371 Date: Jan. 30, 2012

(30) Foreign Application Priority Data
Jul. 31, 2009 (KR) 10-2009-0070989

(51) Int. Cl. A01C 15/00

(52) U.S. Cl. 239/685

(57) ABSTRACT

The present invention relates to a powerless double-distribution fans fertilizer distributor which respectively rotates two disks by driving two wheels by traction so as to distribute a fertilizer, wherein the fertilizer distributor comprises: a hopper (20) which has fertilizer discharge holes in a left and right symmetrical structure and is installed above a body frame (10) having a pulling tool in the front part; wheel shafts (30) divided by left and right which are installed below the frame in such a way that one shaft end is connected with wheels (11) and the other shaft end is placed at the central lower portion of the fertilizer discharge holes (21) of the hopper (20); a clutching gear box (40) which controls the rotation of each wheel shaft, converts the horizontal rotation of wheels to an upward motion by 90 degrees, and is coupled to left and right wheel shaft ends; disk distribution fans (50) and a stirring wing (60) which are coupled to a vertically connected gear shaft (41) of the clutching gear box (40); is and a distribution amount control device (70) which controls distribution amount control plates (72) installed at the each fertilizer discharge holes (21) of the hopper by a lever (71).

### TECHNICAL FIELD

The present invention relates to a powerless distributor which makes it possible to distribute fertilizer in a powerless way in such a manner that a rotation driving force of wheels generating as a tiller, a riding type cultivator, a vehicle or horses and cows carries fertility enhancement fertilizers in a powerless way is converted into a circular disk distribution fan (disc), thus distributing fertilizers powerlessly, and in particular to a powerless double-distribution fans fertilizer distributor characterized in that a fertilizer discharge port is formed symmetrically at left and right sides of a large capacity hopper installed at a frame, and a circular disk distribution fan driving by means of a rotation driving force of wheels is installed at a lower side of each fertilizer discharge port, and fertilizer is concurrently distributed in sync through two circular disc distribution fans driven by means of towing, so fertilizer can be distributed over a wider area, so it is possible to effectively and fast perform a fertilizer distribution work in a wider range of field.

### BACKGROUND ART

There is a tug type powerless fertilizer distributor driving a circular disc distribution fan with the aid of the rotations of wheels by means of tugging for a fertilizer distribution work, thus enhancing fertility for the growth of agriculture, natural lawn or something.

A conventional tug type powerless fertilizer distributor has a hopper with a fertilize discharge port at an upper side of a frame having a tugging part at its front side, and one circular disk distribution fan is installed at a lower side of a fertilizer discharge part of a hoper. The circular disk distribution fan is connected with a wheel shaft, so fertilizer discharged though the fertilizer discharge port is distributed as it is hit by a circular disk distribution fan.

The conventional tug type powerless fertilize distributor uses a driving force from a wheel shaft which can be economically constructed because a motor or a driving device driving a circular distribution fan can be omitted. As a tugging means, an agriculture machine such as a tractor, a tiller, a cultivator, etc. as well as horses and cows and a human power can be directly used, so it can be widely used where an agriculture machine is not provided and used.

However, the conventional tug type powerless fertilizer distributor is formed of one circular disk distributor fan, and a hopper installed depending on the fan is conical and small, so a distribution range is narrow, and a loading capacity is low, for which a wide area fertilizer distribution work as in a golf field or a wide cultivation area is not efficient.

### DISCLOSURE OF INVENTION

Accordingly, it is an object of the present invention to provide a powerless double-distribution fans fertilizer distributor in which in a powerless tugging type fertilizer distributor distributing fertilizer powerlessly by receiving a rotational force of both wheels driven by tugging and converting the same into a rotational driving force of distribution fans, there are provided a large capacity hopper, and a circular disk distribution fan corresponding to each fertilizer discharge port is installed at a lower side of a hopper, thus distributing over a wide range by hitting fertilizer discharged through fertilizer discharge ports disposed at left and right sides. Each distribution fan is connected with both wheel shafts, thus being driven by means of a driving force from each wheel shaft, by means of which it is possible to distribute fertilizer over a wide range of areas in a more effective way.

It is another object of the present invention to provide a powerless double-distribution fertilizer distributor which can help distribute fertilizer in a high capacity and efficiency and effectively distribute fertilizer in a place where cows or horses are used for an agriculture with the aid of a driven tugging apparatus the driving and tugging force of which can be brought from a tractor, a lawn machine, a cultivator, and a motored cart generally used in a golf field or somewhere or can be brought from animals such as cows or horses.

It is further another object of the present invention to effectively use a rotation driving force of wheels when driving a distribution fan by providing a clutching gear box which connects one wheel shaft and one distribution fan shaft.

It is further another object of the present invention to adjust the amount of fertilizer distribution in such a way to limit both the driving sides of a distribution fan installed at left and right sides or limit one side among both the driving sides of a distribution fan installed at left and right sides by means of an intermittent lever operation of a clutch.

In addition, it is further another object of the present invention to provide a fertilizer distributor in which the distribution amount of fertilizer can be concurrently adjusted by means of one lever operation by allowing a distribution amount adjusting apparatus installed at both fertilizer discharge ports of a hopper to operate in sync.

### Advantageous Effects

In the present invention, since fertilizer distribution is performed by way of two portions with the aid of a circular disk distribution fan installed at left and right sides, fertilizer can be distributed over wider area at a time, and a large capacity hopper helps efficiently distribute fertilizer in a wide range of area continuously.

The present invention is advantageous to fast and uniformly distribute a lot of fertilizer at a time using a large capacity hopper, and it is possible to distribute fertilizer through one side or at two sides, so the amount of distribution can be selectively controlled, and distribution efficiency can be enhanced.

The present invention is directed to driving a distribution fan and an agitating blades by means of a rotation force of wheels generating when wheels rolls by a tugging means, so fertilizer distributions can be made possible by a certain driving force transfer means such as a tractor, a tiller, a lawn machine, and a cultivator as well a noise-free motored vehicle or animal such as horses or cows.

The present invention is advantageous to freely perform a driving force intermittent operation in such a way to adjust a distribution amount by intermitting both the driving forces of distribution fans installed in the left and right directions or one of the driving forces of distribution fans installed in the left and right directions by means of an intermittent lever operation as a driving force of wheel shafts is converted into a driving force for distribution fans with the aid of a clutching gear box structure of the present invention.

The present invention provides an advantage maintaining the distribution amount of fertilizer distributed from both sides identical as two distribution amount adjusting plates work in sync, thus also providing a function of controlling the above operation at a time.

### BRIEF DESCRIPTION OF THE DRAWINGS

The present invention will become better understood with reference to the accompanying drawings which are given only by way of illustration and thus are not limitative of the present invention, wherein;

FIGS. 1 and 2 views illustrating a construction of a distributor according to the present invention;

FIGS. 3 and 4 are views illustrating a structure of a construction of a clutch gear box 40 and a housing according to the present invention;

FIG. 5 is a disassembled view illustrating a distribution amount adjusting apparatus according to the present invention;

FIG. 6 is a view illustrating a construction of a clutch gear box of a distributor according to the present invention;

FIG. 7 is a view illustrating an operation of a distribution amount adjusting apparatus according to the present invention; and

FIG. 8 is a view illustrating a construction of a clutch connection according to the present invention.

*Descriptions of Reference Numerals of Major Elements

| | | | |
|---|---|---|---|
| 10: | body frame | 11: | wheels |
| 12: | tugging part | 20: | hopper |
| 21: | fertilizer discharge port | 30: | wheel shafts |
| 31: | spline | 32: | housing |
| 33: | bearing | 40: | clutch gear box |
| 41: | gear shaft | 411: | gear |
| 412: | bearing | 412: | bearing |
| 42: | casing | 44: | bevel gear |
| 441: | toenail | 45: | clutch |
| 451: | toenail | 452: | spline groove |
| 453: | pork engaging groove | 46: | column |
| 46: | pork | 462: | tube |
| 463: | fixing bolt | 464: | groove |
| 47: | intermittent lever | 472: | connection bar |
| 473: | wire | 474: | bracket |
| 475: | roller | 476: | spring |
| 50: | circular disk distribution fan | 60: | agitating blades |
| 70: | distribution amount adjusting apparatus | | |
| 71: | lever | | |
| 72: | distribution amount adjusting plate | | |
| 721: | fertilizer discharge port | | |
| 722: | arm | 73: | first link |
| 74: | second link | 80: | connection tube |

### BEST MODES FOR CARRYING OUT THE INVENTION

To achieve the above objects, as an embodiment of the present invention, there is provided a powerless double-distribution fan fertilizer distributor which comprises a hopper 20 which has a pair of left and right symmetrical fertilizer discharge ports at an upper side of a body frame 10 in front of which a tugging part 12 is disposed; a pair of wheel shafts 30 which are separated in left and right sides so that one shaft end is secured to the wheel 11 and the other shaft end is positioned at a center lower side of the fertilizer discharge part 21 of the hopper 20; a pair of clutch gear boxes 40 which are secured to left and right wheel shafts so as to intermit the rotation of each wheel shaft and convert the rotation of the wheel in an upper direction at an angle of 90 degrees; a pair of circular dish distribution fans 50 which are secured to the gear shafts 41, respectively, with a gear shaft 41 being installed in a vertical direction of the clutch gear box 40; agitating blades 60 which are secured to the ends of each gear shaft as each gear shaft passes through the interior of the hopper; and a distribution amount adjusting apparatus 70 which is secured to the fertilizer discharge port 21 of each hopper, thus adjusting the discharge amount, wherein distribution is performed as two circular disk distribution plates rotate with the aid of tugging operations by means of two wheels.

The present invention is characterized in that a shaft part of a wheel shaft with a spline is extended to a hexagonal case and is installed in the interior of a housing, and is supported by a bearing. A bevel gear with toenails on its outer side is rotatably installed at the wheel shaft, and a toenail mating with the toenail of the bevel gear is installed at an outer side of the bevel gear, and a spline groove is formed at a center, and a clutch with a port engaging groove at its outer portion is engaged to the wheel shaft spline, and the port of the column extended toward an outer side of a cylindrical case is engaged with the pork engaging groove of the clutch, and the column is engaged with an intermittent lever, by means of which it is possible to concurrently intermit the operations of the distribution fans installed at left and right sides with the aid of an operation of the intermittent lever. Alternatively, it is possible to intermit one of the driving operations of the distribution fans installed in left and right directions by means of the operation of the intermittent lever, thus adjusting the amount of the distribution.

The bevel gear is engaged to the wheel shaft, and the gear is engaged with the bearing so as to support the lower side of the gear shaft. As the gear of the gear shaft and the bevel gear of the wheel shaft come into contact with each other, thus transferring driving force.

The rotation of the wheel shaft is intermitted by means of a clutch and is transferred to the gear shaft protruded in a vertical direction as the wheel shafts rotate, so the distribution fans and the agitating blades connected with the gear shaft with driven force are driven.

The present invention provides a distribution amount adjusting apparatus which is characterized in that a distribution amount adjusting plate installed at each fertilizer discharge port of a lower side of each hopper is connected with the first link, and the distribution amount adjusting plate of one side is connected with a second link of the distribution amount adjusting lever, so the distribution amount adjusting plates of both sides operate in sync based on the operation of the adjusting lever, thus concurrently adjusting the distribution amounts.

The present invention provides a powerless double-distribution fan fertilizer distributor characterized in that left and right clutch gear boxes are connected by way of a connection tube, and the left and right clutch gear boxes are integrally fix-engaged with the body frame or are separated from each other and are fix-engaged to the body frame, respectively.

The distribution amount adjusting apparatus according to the present invention is characterized in that the distribution amount adjusting plate installed at each fertilizer discharge port of a lower side of a hopper is connected with a first link, and the distribution amount adjusting plate of one side is connected to a second link, so the distribution amount adjusting plates of both sides work in sync depending on the operation of lever in the powerless double distribution fan fertilizer distributor.

The present invention provides a powerless double distribution fan fertilizer distributor characterized in that a clutch gear box is designed to concurrently intermit the operations of the distribution fans installed in left and right directions by means of an operation of a clutch intermittent lever or it is possible to intermit one operation of the distribution fans installed in left and right directions by means of an operation of a clutch intermittent level.

### Modes for Carrying Out the Invention

The preferred embodiments of the present invention will be described in details with reference to the accompanying drawings.

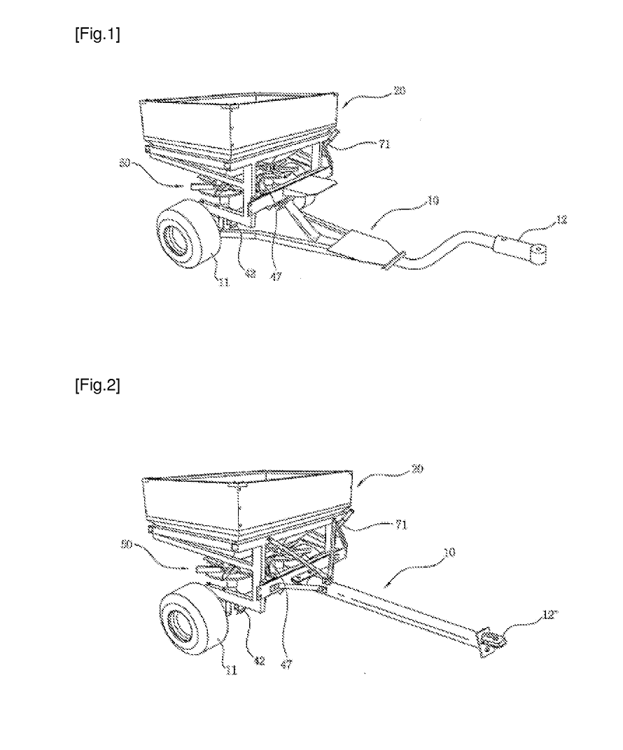

FIGS. 1 and 2 are views illustrating a construction of a powerless double distribution fan fertilizer distributor according to the present invention, of which FIG. 1 is a view of an example of a tiller, and FIG. 2 is a view of an example of a cultivator, a vehicle, an ATM (all-terrain vehicle).

The construction of the present invention will be described. A hopper 20 with a fertilizer discharge port in a left and right symmetrical shape is installed at an upper side of the body frame 10 in front of which a tugging part 12 is installed. The left and right-divided wheel shaft 30 is installed at a lower side of the frame so that one shaft end is connected with the wheel 11, and the other shaft end is positioned at a center lower side of the fertilizer discharge port 21 of the hopper 20. A clutch gear box 40 intermitting the rotations of each wheel shaft and converting at an angle of 90 degrees the rotation of the wheels is engaged to two wheel shaft ends of left and right sides, and a gear shaft 41 is is installed in a vertical direction of the clutch gear box 40, and two circular disk distribution fans 50 are engaged to the gear shaft 41, and each gear shaft passes through the interior of the hopper, and the agitating blade 60 is engaged to its end, and the distribution amount adjusting apparatus 70 adjusting the discharge amount is installed at the fertilizer discharge port 21 of each hopper.

In the above construction, the body frame 10 is characterized in that the wheels 11 are engaged at left and right sides for movement, and the hopper 20 is installed at an upper side, and the tugging parts 12, 12′ are installed in front of the same.

The tugging parts 12 and 12′ can be implemented in various shapes and are basically directed to tugging a distributor by connecting a tractor, a tiller, a cultivator, a lawn machine, a noise-free motored vehicle or horses or cows.

As shown in FIG. 1, the tugging part used a tiller as a tugging means in which the front side of the body frame is made in a straight shape, and a plug type tugging part matching with a socket connector of a tiller is provided at an end portion of the same.

As shown in FIG. 2, the attachment body is formed in a straight shape when it is used as a means for tugging a cultivator, an ATV, a vehicle, horses or cows, etc., of which one side is mated and engaged with the joint, thus forming a holder engaging part, and the other side forms a bar structure is protruded from a body like a whippletree connecting a rope of a yoke, so the yoke is hung on a cow back, and the rope is tied to the whippletree, thus finishing a connection to the horses or cows.

When the motored vehicle or common vehicle is used as a tugging means, a tugging part of a ball cup structure is provided at a front end of the body frame, and is connected at a tugging rod attached to a vehicle.

The tugging part might be implemented in various shapes to match with the tugging means generally used. It is not limited thereto in the present invention.

The hopper 20 is a space for storing fertilizer to be distributed, and might be formed in a cubic box shape as shown in the drawings and might be implemented in various shapes. A left and right symmetrically-structured fertilizer discharge part 21 is provided at a lower side, thus discharging the stored fertilized through the lower fertilizer discharge port.

The bottom of the hopper with the fertilizer discharge port 21 is divided into two sides toward the fertilizer discharge port of both sides so as to smoothly guide the discharge of fertilizer in the hopper and is getting narrower into a downward direction.

The fertilizer distribution amount adjusting apparatus 70 is configured in such a way that the fertilizer discharge port 21 is formed of two holes, so the fertilizer discharge amount can be adjusted by opening or closing the holes.

The wheel shaft 30 is a shaft connected with the wheels so as to use the rotation of the wheels 11 for the operation of the distribution fans and is connected with the clutch gear box 40 for thereby forming a main driving shaft, thus performing an operation that the rotational force is outputted to the gear shaft 41 forming the driven shaft of the clutch gear box, so the rotations of the wheels are converted into the driving force of the distribution fans.

The clutch gear box 40 might be formed in various forms as a gear box which is directed to converting the rotation of the wheel shafts into 90° rotations, thus driving the distribution fans, and intermitting the driving force with the aid of the clutch in the interior.

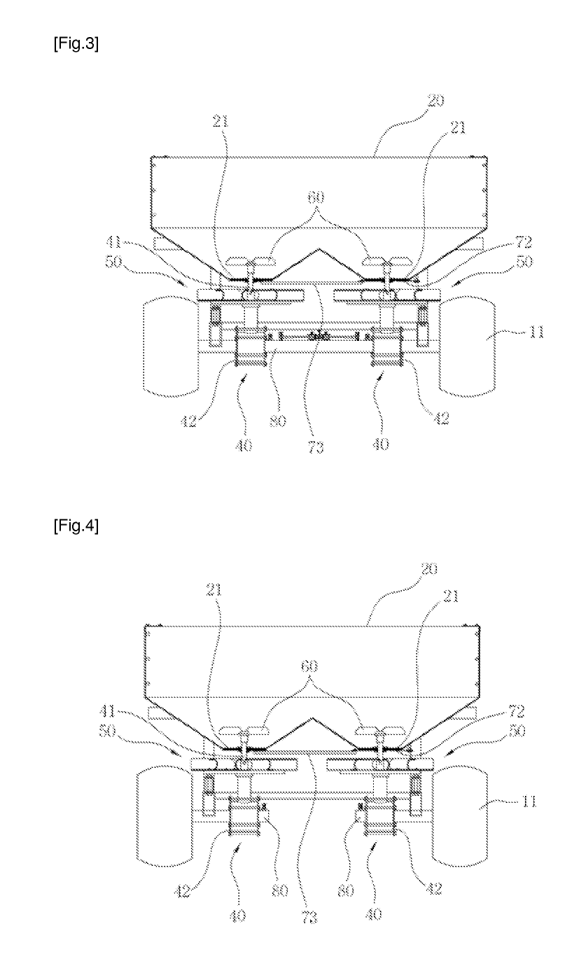

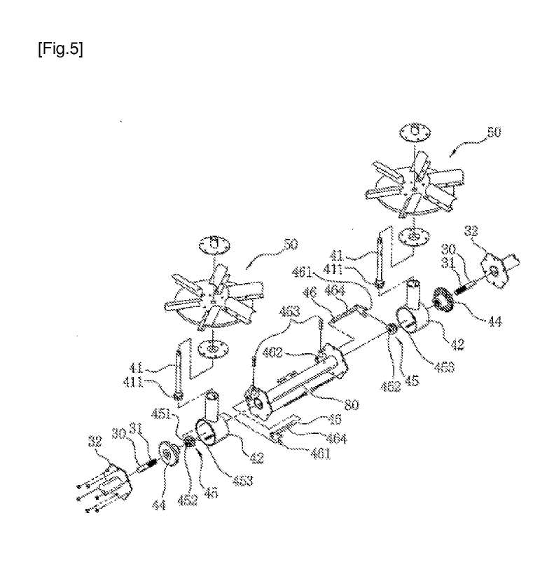

FIGS. 3 and 4 are views illustrating an engagement of the clutch gear box 40 according to the present invention, and FIGS. 3 and 5 are views illustrating a construction that the left and right clutch gear boxes 40 are integrally engaged by means of the connection tube 80, and FIG. 4 is a view illustrating an example that left and right clutch gear boxes are separated without using a connection tube.

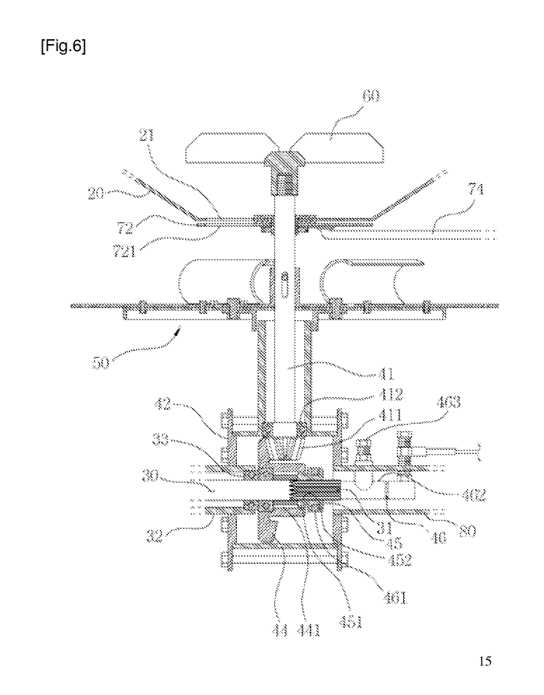

As shown in FIG. 6, a bearing 33 is installed in the interior of the housing 32 so that a shaft end of the wheel shaft 30 with the spline 31 is extended to the hexagonal case 42, and the bevel gear 44 with the toenail 441 at the outer side is rotatably inserted into the wheel shaft 30 belonging to the hexagonal case 42, and the toenail 451 mating with the toenail 441 of the bevel gear is formed at an outer side of the bevel gear 44, and a spline groove 452 is formed at a center portion, and the clutch 45 with the port engaging groove 453 is engaged to the wheel shaft spline 31 at the outer side, and the pork engaging groove 453 of the clutch 45 is engaged with the pork 461 of the column 46 exposed to the outside of the hexagonal case 42, and the column 46 is engaged to the intermittent lever 47 at the outside of the case, so the operations of the distribution fans 50 installed in left and right directions can be intermitted by means of the operation of the clutch intermittent lever 47.

In the present invention, the distribution amount distribution can be adjusted in such a way to intermit one operation between left and right direction operations in terms of the driving operations of the distribution fan 50 installed in left and right directions by means of the operation of the clutch intermittent lever 47 if necessary.

The bevel gear 44 is connected to the wheel shaft 30, and the gear 411 is connected with the bearing 412 so as to support the lower side of the gear shaft 41, so the driving force is transferred as the gear 411 of the gear shaft 41 and the bevel gear 44 of the wheel shaft come into contact with each other.

As the rotation of the wheel shaft 30 is intermitted by means of the clutch 45 and is applied to the vertically protruded gear shaft 41, the distribution fans 50 and the agitating blades 60 connected to the gear shaft rotate and are driven.

The left and right wheel shafts 30 are inserted into the housing 32 and are supported, and the housing is connected to the clutch gear box 40 by means of the flange and is fixedly engaged to the body frame, so the wheel shaft, the housing, the clutch gear box and the distribution fans are secured to the body frame, respectively.

As the left and right clutch gear boxes 40 are connected by way of the connection tube 80, thus obtaining a durable connection, but the connection tube 80 might be omitted.

The operation of the clutch gear box might be divided into a state in which a driving force is disconnected as the rotation of the wheel shaft 30 is not transferred to the gear shaft 41 vertically formed, and a state in which the driving force is connected as the rotation of the wheel shaft is applied to the gear shaft 41.

\textcircled{1} A state that the driving force of the clutch gear box is disconnected.

When the wheels 11 roll by means of the movement of the fertilizer distributor by means of a tugging means, the wheel shaft 30 secured to the wheels rotate in sync with the wheels in the housing 32 at a ratio of 1:1.

The bevel gear 44 and the clutch 45 are sequentially engaged in the hexagonal case 42 of the shaft end of the wheel shaft 30; however the bevel gear 44 is secured in pair with respect to the wheel shaft, so the bevel gear 44 keeps a stopped state irrespective of the rotations of the wheel shafts.

The clutch 45 is secured to the spline 31 formed at a shaft end of the wheel shaft, thus maintaining a rotation state as it rotates depending on the rotation of the wheel shaft.

The toenail 451 formed at the clutch and the toenail 451 formed at the bevel gear 44 are spaced apart from each other, so the rotational force of the wheel shafts is transferred to the cutch 45; however it is not transferred to the bevel gear 44, so the driving force remains disconnected.

In the state that the driving force is disconnected, the load of the distribution fans secured to the gear shaft is not applied to the wheels, it is light to move, and a distribution can be done as driving force is connected to one of the distribution fans.

\textcircled{2} A state that the driving force of the clutch gear box is connected.

When the intermittent lever 47 is moved being connected, the column 46 secured to the intermittent lever is pushed toward the hexagonal case 42 and pushes the rotating clutch 45 secured to the spline 31, so the toenail 451 of the clutch 45 and the toenail 441 of the bevel gear 44 approach each other for engagement. So, the rotational force of the wheel shaft is transferred to the clutch, and the bevel gear engaged with the clutch rotates.

Since the gear 411 of the gear shaft 41 is engaged with the bevel gear 44, it rotates depending on the rotation of the bevel gear, so the driving force is applied to rotate the distribution fans and the agitating blades.

The gear ratio of the bevel gear 44 and the gear 411 of the gear shaft 41 is approximately 4˜8:1, and the distribution fans rotate 4˜8 turns per one revolution, thus obtaining a rotational force enough for the distribution of fertilizer.

As shown in FIG. 6, the structure of the clutch gear box is characterized in that the fixing bolt 463 is installed at the tube 462 which is to guide the column 46 so as to limit the operation of the clutch intermitted by means of the forward and backward movements of the column, and the groove 464 corresponding to the fixing bolt is formed at the column contacting with the fixing bolt, thus tightening the bolt, so it is possible to obtain the driving force which is intermittently connected or disconnected.

The structure that the fixing bolt 463 is secured is basically directed to preventing the connection of the driving force to the distribution fans during the movement and to eliminating potential danger which might occur due to the rotation of the distribution fans while preventing the loss of driving force.

The clutch gear boxes are secured to the left and right wheel shafts, so it is possible to separately drive each distribution fan or to concurrently drive both the distribution fans.

A hollow connection tube 80 is connected between the clutch gear boxes of both sides, thus stably supporting the wheel shafts to the body frame.

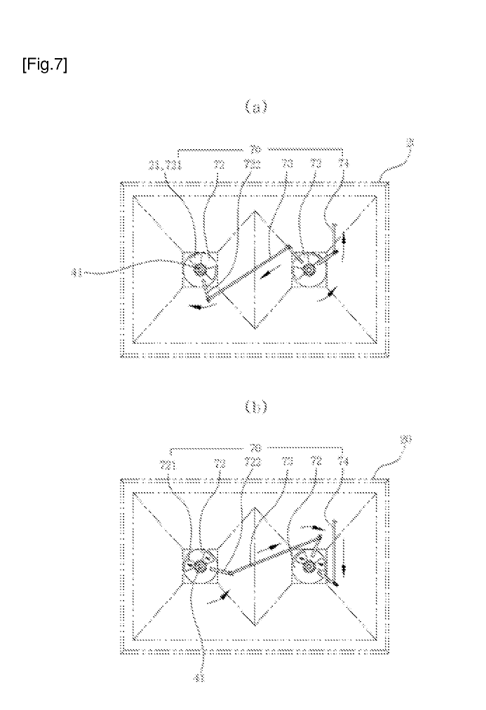

FIG. 7 is a view illustrating the distribution amount adjusting apparatus 70 according to the present invention in which the distribution amount adjusting plate 72 installed at each fertilizer discharge port 21 of the lower side of the hopper 20 is connected by way of the first link 73, and the distribution amount adjusting plate of one side is connected to the lever 71 by way of the second link 74, so the distribution amount adjusting plates 72 of both sides operate in sync with each other depending on the operation of the lever 71, thus adjusting the amount of distribution.

The distribution amount adjusting plate 72 is characterized in that the fertilizer discharge port 721 corresponding to the fertilizer discharge port 21 formed at the bottom of the hopper is formed, and an arm 722 is formed at an outer side of the circular plate so that a smooth link operation can be performed by connecting the first link and the second link.

The sync operations in terms of the adjustment of the distribution amount is advantageous to identically maintain the amount of distribution in left and right directions by means of a lever operation of one time.

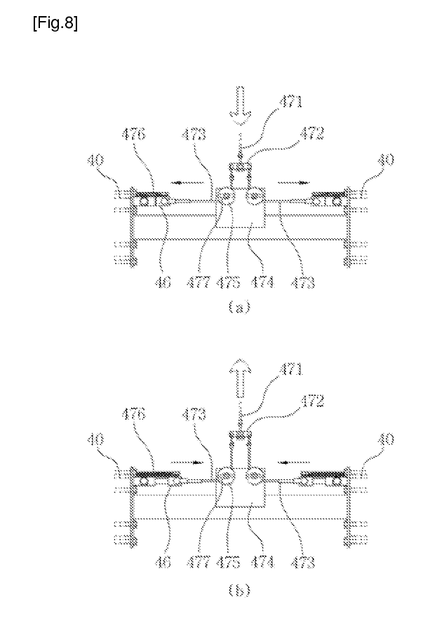

As shown in FIG. 8, the connection bar 472 is secured to the end of the wire 471 connected to the driving end of the intermittent lever 47, and the divided wires 473 are connected to both ends of the connection bar 472, and the divided wire 473 is hung over the roller 475 supported by mans of the bracket 474 fixed at the body frame 10, thus being connected to the column 46 of each clutch gear box 40, and the column is connected with the spring 476, so it is applied toward the clutch gear box 40.

As shown in FIG. 8(a), in the above structure, when the intermittent lever is pushed in using one intermittent lever 47, the column 46 moves forward with the aid of spring force, so the clutches of both the clutch is gear boxes are engaged, thus connecting driving force.

As shown in FIG. 8(b), in the above structure, when the intermittent level 47 is pulled, the column 46 connected with the wire moves backward, and the clutches are separated, and the driving forces of the clutch gear box are disconnected, so the intermittent operations of driving force are simple, and it is advantageous to concurrently control the driving force applied to both distribution fans by means of one intermittent lever.

The present invention is advantages to concurrently distribute fertilizer of the hopper in both directions with the aid of various tugging means which are simple tugged. If necessary, the fertilizer discharge port of one side can be closed, and the distribution fan rotation driving force is disconnected, so distribution can be performed in one direction. So, it is possible to effectively perform a distribution work depending on the purpose of distribution.

### INDUSTRIAL APPLICABILITY

As described above, the present invention is directed to generating a driving force needed for tugging from a motored vehicle or animal such as horses or cows, so a large capacity distribution and a high efficiency distribution can be made possible with the aid of motored tugging apparatuses. An effective fertilization work can be down in a farm field where uses animal such as cows is or horses, and the present invention can be very efficiently applied to a mass agriculture area.

1. A powerless double-distribution fan fertilizer distributor, comprising:
a hopper 20 which has a pair of left and right symmetrical fertilizer discharge ports at an upper side of a body frame 10 in front of which a tugging part 12 is disposed;
a pair of wheel shafts 30 which are separated in left and right sides so that one shaft end is secured to the wheel 11 and the other shaft end is positioned at a center lower side of the fertilizer discharge part 21 of the hopper 20;
a pair of clutch gear boxes 40 which are secured to left and right wheel shafts so as to intermit the rotation of each wheel shaft and convert the rotation of the wheel in an upper direction at an angle of 90 degrees;
a pair of circular dish distribution fans 50 which are secured to the gear shafts 41, respectively, with a gear shaft 41 being installed in a vertical direction of the clutch gear box 40;
agitating blades 60 which are secured to the ends of each gear shaft as each gear shaft passes through the interior of the hopper; and
a distribution amount adjusting apparatus 70 which is secured to the fertilizer discharge port 21 of each hopper, thus adjusting the discharge amount, wherein distribution is performed as two circular disk distribution plates rotate with the aid of tugging operations by means of two wheels.

2. A powerless double-distribution fan fertilizer distributor of claim 1, wherein said left and right clutch gear boxes 40 are connected by way of a connection tube 80, and the left and right clutch gear boxes 40 are integrally secured to the body frame, and the distribution is performed as two circular disc distribution fans rotate by tugging operations with two wheels.

3. A powerless double-distribution fan fertilizer distributor of claim 1, wherein said left and right clutch gear boxes 40 are separate from each other and are secured to the body frame, respectively, so distribution is performed as two circular plate disk distribution fans rotate based on the tugging by two wheel operations.

4. A powerless double-distribution fan fertilizer distributor of claim 1, wherein said distribution amount adjusting apparatus 70 is characterized in that a distribution amount adjusting plate 72 installed at each fertilizer discharge port 21 of a lower side of the hopper 20 is connected to the first link 73, and the distribution amount adjusting plate of one side is connected to the lever 71 by way of the second link 74, and both the distribution amount adjusting plates 72 of both sides operate in sync, so distribution is performed as two circular plate disk distribution fans rotate based on the tugging by two wheel operations.

5. A powerless double-distribution fan fertilizer distributor of claim 1, wherein said clutch gear box 40 concurrently intermit the operation of the distribution fans 50 installed in left and right directions by means of an operation of the clutch intermittent lever 47, thus adjusting the distribution amount, so distribution is performed as two circular plate disk distribution fans rotate based on the tugging by two wheel operations.

6. A powerless double-distribution fan fertilizer distributor of claim 5, wherein one of the operations of the distribution fans 50 installed in left and right directions is intermitted by means of an operation of the clutch intermittent lever 47, thus adjusting the distribution amount, so distribution is performed as two circular plate disk distribution fans rotate based on the tugging by two wheel operations.
